(19) United States
(12) Patent Application Publication
(10) Pub. No.: US 2012/0200159 A1
(43) Pub. Date: Aug. 9, 2012

(54) SEMICONDUCTOR DEVICE

(75) Inventors: Mitsuaki KATAGIRI, Tokyo (JP); Ken Iwakura, Tokyo (JP); Yutaka Uematsu, Tokyo (JP)

(73) Assignee: Elpida Memory, Inc.

(21) Appl. No.: 13/366,717

(22) Filed: Feb. 6, 2012

(30) Foreign Application Priority Data
Feb. 9, 2011 (JP) 2011-026439
Nov. 2, 2011 (JP) 2011-241620

(51) Int. Cl. H02J 4/00

(52) U.S. Cl. 307/43

(57) ABSTRACT

A semiconductor device includes: first and second power supply wirings VDDQ and VSSQ, respectively; an output circuit 12 arranged between VDDQ and VSSQ; and a noise cancellation circuit 13 arranged between VDDQ and VSSQ. The noise cancellation circuit 13 produces a damped oscillation for the SSN oscillation noise that is generated when a logic level outputted to an output node of the output circuit is switched and that exponentially damps and oscillates at a predetermined period. The damped oscillation produced by the noise cancellation circuit 13 is delayed by half a period of the SSN oscillation noise and has a direction opposite to that of the SSN oscillation noise and hence the damped oscillation and the SSN oscillation noise counteract each other.

### REFERENCE TO RELATED APPLICATION

This application is based upon and claims the benefits of the priorities of Japanese patent application No. 2011-026439, filed on Feb. 9, 2011 and Japanese patent application No. 2011-241620, filed on Nov. 2, 2011, each disclosure of which is incorporated herein in its entirety by reference thereto. The present invention relates to a semiconductor device. In particular, it relates to a semiconductor device in which a power supply oscillation noise generated during switching of an output signal is suitably reduced.

### TECHNICAL FIELD

### Background

Along with the increase in signal transmission rate, assurance of a noise margin and a timing margin in designing a semiconductor device is becoming increasingly difficult year after year. Particularly, in the case of a DRAM (Dynamic Random Access Memory) or the like, to realize high-speed single-ended signal transmission over Gbps (Giga-bits per second), for example, it is essential to reduce the SSN (Simultaneous Switching Noise) generated when output signals from a plurality of output circuits (output buffers) are simultaneously switched. When output signals from a plurality of output circuits are switched simultaneously from one logic level (a low level or a high level) to the other logic level, a large switching noise is generated in high- and low-potential power supplies (VDDQ) and (VSSQ).

The following describes the switching noise briefly based on an example in which output signals from N output circuits are simultaneously switched from a low level to a high level. Assuming that an inductance of a power supply network between a high-potential power supply (VDDQ) and high-potential power supply nodes of the output circuits on a semiconductor LSI (Large Scale Integrated circuit) is L_{DD}, a power supply current is I_{DD}, and currents flowing from the power supply VDDQ to load capacitances Cⱼ (j=1 to N) connected to the output nodes of the N output circuits are I (I_{DD}=ΣIᵢ), a voltage V′DDQ at each high-potential power supply terminal of the output circuits on the semiconductor LSI is represented by the following expression.

$${V}^{′} DDQ = VDDQ - {L}_{DD} \frac{d {I}_{DD}}{d t} = VDDQ - {L}_{DD} {\sum }_{j = 1}^{N} \frac{d {I}_{j}}{d t} \qquad ( 1 )$$

Likewise, an example in which output signals from the N output circuits are simultaneously switched from a high level to a low level will be described. Assuming that an inductance of a power supply network between a low-potential power supply (VSSQ) and low-potential power supply nodes of the output circuits is L_{SS}, a power supply current is I_{SS}, and currents flowing from load capacitance Cⱼ (j=1 to N) connected to output nodes of the N output circuits to the low-potential power supply (ground) VSSQ are (I_{SS}=ΣIⱼ), a voltage V′SSQ at each low-potential power supply terminal of the output circuits is represented by the following expression.

$${V}^{′} SSQ = VSSQ + {L}_{DD} \frac{d {I}_{SS}}{d t} = VSSQ + {L}_{SS} {\sum }_{j = 1}^{N} \frac{d {I}_{j}}{d t} \qquad ( 2 )$$

Thus, by the SSN switching noise, high- and low-level voltages (VOH) and (VOL) of the output signals from the output circuits on the semiconductor LSI are reduced from VDDQ and VSSQ by L_{DD}×dI_{DD}/dt and L_{SS}×dI_{SS}/dt, respectively, resulting in a decrease in noise margin. In addition, for example, because of such signal distortion, signal integrity is deteriorated and timing jitter is increased. In practice, depending on impedance characteristics of the power supply network, the SSN is accompanied by a power supply oscillation noise.

Patent Document 1 discloses a method for switching a pulse period of a pulse generation circuit, in which a first oscillator outputs a first pulse signal having a square wave, a control unit outputs a first control signal for controlling a period of the first pulse signal, a second oscillator outputs a second pulse signal having a square wave, and the control unit outputs a second control signal for controlling a period of the second pulse signal, so that the period is set to be constantly shorter than that of the first pulse signal, and a switching unit receives the first and second pulse signals and selectively outputs one of the first and second pulse signals based on a switching signal supplied from the control unit. According to the method for switching the pulse period of a pulse generation circuit disclosed in Patent Document 1, it is possible to realize a stable pulse generation circuit that generates no pulse-shaped noise at a switching point.

Patent Document 2 discloses a noise reduction circuit for reducing a noise generated by a fluctuation of a reference voltage by simultaneous change of outputs from output circuits on an LSI configured by MOS transistors. The noise reduction circuit includes: a processing circuit that is arranged in a preceding stage of an output buffer that outputs data and that delays input data and supplies the delayed input data to the output buffer; and a delay means that controls an operation timing of the processing circuit based on an input control signal. Under the control of the delay means by an external operation, the processing circuit is switched to operate at a normal timing (output timing 1) or at a delay timing (output timing 2).
[Patent Document 1]
Japanese Patent Kokai Publication No. JP-H07-170160A
[Patent Document 2]
Japanese Patent Kokai Publication No. JP-H07-249976A

### SUMMARY

Following describes the analysis of the related techniques.

There are two types of power supply noises due to the SSN, as follows:

(A) a spike-shaped noise which is generated when output signals are switched; and
(B) an oscillation noise which is generated by an impedance characteristic of a power supply network of an output circuit.

In the related techniques, a spike-shaped noise having a large noise amplitude is reduced by a noise cancellation circuit. However, along with the increased transmission rate of a signal, the reduction of the oscillation noise (B), which has a great effect on a jitter, has become indispensable.

The above Patent Document 1 is directed only to the pulse-shaped noise (A) generated simultaneously with a switching and hence the oscillation noise (B) cannot be cancelled.

According to Patent Document 2, timings of a plurality of outputs from the LSI are divided into two types, and the switching timings are shifted. However, no matter how the switching timings are shifted, the power supply noise generated when the output buffers are switched cannot be cancelled. In addition, Patent Document 2 does not disclose a means of cancelling the oscillation noise (B).

According to the present invention, which seeks to solve at least one of the above described issues there may be provided the following configuration, but not limited thereto.

According one aspect of to the present invention, there is provided a semiconductor device, comprising:

first and second power supply wirings connected to first and second power supplies, respectively, having power supply potentials different from each other;

an output circuit connected between the first and second power supply wirings, receiving an input signal, and outputting, based on the input signal, an output signal having a logic level corresponding to the first or second power supply voltage to an output node; and

a noise cancellation circuit connected between the first and second power supply wirings and producing a power supply oscillation for a power supply oscillation noise generated in at least one of the first and second power supply wirings when a logic level outputted to the output node of the output circuit is switched, the power supply oscillation being delayed from the power supply oscillation noise by a predetermined time and having a direction opposite to that of the power supply oscillation noise, to make the power supply oscillation and the power supply oscillation noise counteract each other.

According to the present invention, an SSN oscillation noise of output circuits can be reduced. According to the present invention, a single-end output signal can be suitably transmitted at high speed.

Still other features and advantages of the present invention will become readily apparent to those skilled in this art from the following detailed description in conjunction with the accompanying drawings wherein only exemplary embodiments of the invention are shown and described, simply by way of illustration of the best mode contemplated of carrying out this invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a diagram illustrating a configuration of a first exemplary embodiment of the present invention.

FIG. 2 is a diagram illustrating operation principles of the present invention.

FIG. 3 is a diagram illustrating a configuration of a second exemplary embodiment of the present invention.

FIG. 4 is a diagram illustrating a configuration of a third exemplary embodiment of the present invention.

FIG. 5 is a diagram illustrating a configuration of a fourth exemplary embodiment of the present invention.

FIG. 6 is a diagram illustrating a configuration of a fifth exemplary embodiment of the present invention.

FIG. 7 is a timing diagram illustrating an operation example of the first exemplary embodiment of the present invention.

FIG. 8 is a diagram illustrating the operation of an embodiment of the present invention.

FIG. 9 is a diagram illustrating a configuration of a specific example of the first exemplary embodiment of the present invention.

FIG. 10 is a diagram illustrating a configuration example of a dummy buffer in FIG. 9.

FIGS. 11A, 11B, 11C and 11D are diagrams illustrating configuration examples of a delay adjustment circuit in FIG. 10.

FIG. 12 is a diagram illustrating another configuration example of an amplitude adjustment circuit in FIG. 10.

FIG. 13 is a diagram illustrating still another configuration example of the amplitude adjustment circuit in FIG. 10.

### PREFERRED MODES

A power supply noise ascribable to the SSN (Simultaneous Switching Noise) which is generated when output signals from a plurality of output circuits (output buffers) on a semiconductor LSI are simultaneously switched, includes an oscillation noise having a grievous effect on a jitter. According to the present invention, a semiconductor device is configured to include a circuit that produce an oscillation that is delayed from the power supply oscillation noise by a predetermined time period and that oscillates in almost exactly in the direction opposite to that of the power supply oscillation noise, as a result of which these oscillation noises cancel out each other. In this way, the deterioration of signal integrity, such as distortion of a signal waveform ascribable to the SSN, can be prevented. For example, a signal can be transmitted at high speed in a single-ended form.

More specifically, a semiconductor device according to the present invention includes a noise cancellation circuit that is connected between first and second power supply wirings and that receives a signal switching an output signal of an output circuit. The noise cancellation circuit produces a damped oscillation (power supply oscillation) that is delayed, from a power supply oscillation noise ascribable to the SSN generated immediately after switching of output signals from output circuits, by half a period of the power supply oscillation noise and that has a phase opposite to that of the power supply oscillation noise ascribable to the SSN. The damped oscillation and the power supply oscillation noises can counteract each other. As a result, the power supply oscillation noise ascribable to the SSN can be reduced.

The present invention is effective in reducing a power supply noise (power supply oscillation noise) generated when multiple-bit parallel output signals are simultaneously switched, as will be described in some of the following exemplary embodiments. However, of course, the present invention is also effective in reducing a power supply noise generated when a single output signal is switched.

### Exemplary Embodiment 1

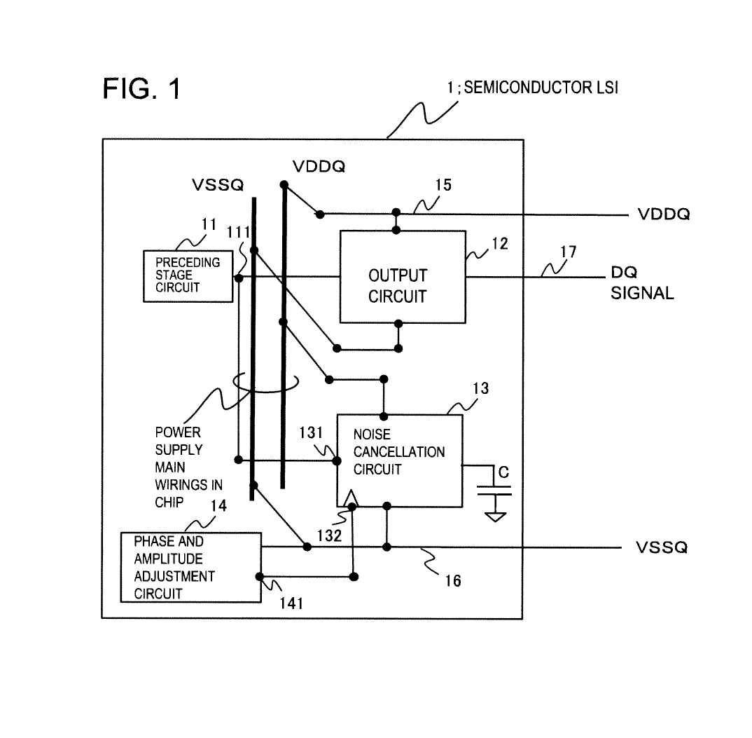

FIG. 1 illustrates a configuration of a first exemplary embodiment of the present invention. A semiconductor LSI 1 includes an output circuit (output buffer) 12 connected between first and second power supply wirings 15 and 16, a noise cancellation circuit 13 connected between the first and second power supply wirings 15 and 16, and a phase and amplitude adjustment circuit 14. The first and second power supply wirings 15 and 16 are connected to high- and low-potential power supplies VDDQ and VSSQ (ground), respectively, which are supplied from the outside of the semiconductor LSI 1. A preceding stage circuit 11 is an internal circuit (a circuit arranged in front of the output circuit 12) of the semiconductor LSI 1 and supplies a data signal 111 to the output circuit 12. The output circuit 12 receives the data signal 111 from the preceding stage circuit 11 and outputs a data (DQ) signal 17 from an output node. The preceding stage circuit 11 and the phase and amplitude adjustment circuit 14 are driven by an internal power supply voltage (step-down power supply voltage) (not illustrated) but are not limited thereto. The output circuit 12 receives the data signal 111 having a low amplitude (amplitude of the internal power supply voltage), executes a level-shift operation, and outputs the DQ signal 17 (amplitude of VDDQ to VSSQ) from the output node.

The noise cancellation circuit 13 includes an input node 131 for receiving the signal 111 from the preceding stage circuit 11 and an input node 132 for receiving a signal (parameters for setting an operation of the noise cancellation circuit 13: delay amount information and amplitude amount information) 141 from the phase and amplitude adjustment circuit 14. While FIG. 1 illustrates only one output circuit 12 for simplicity, a plurality of output circuits 12 may be arranged and a noise cancellation circuit 13 may be arranged for each of the output circuits 12. Alternatively, as described in the following exemplary embodiments, a single noise cancellation circuit 13 may be arranged commonly for a plurality of output circuits 12.

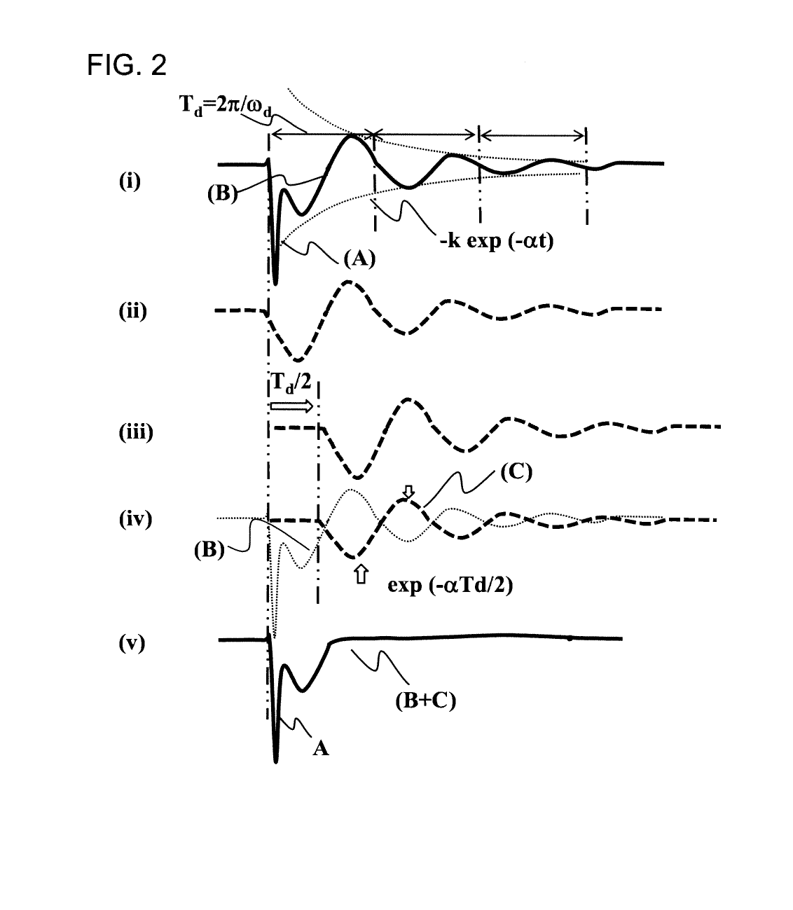

The noise cancellation circuit 13 adjusts a timing of an operation relating to the data signal 111 supplied from the preceding stage circuit 11 and a power supply current amount during the operation, based on delay amount information and amplitude amount information supplied from the phase and amplitude adjustment circuit 14. The delay amount information and amplitude amount information will be described with reference to FIG. 2 later. As with the output circuit 12, the noise cancellation circuit 13 is inserted between the first and second power supply wirings 15 and 16. In addition, the noise cancellation circuit 13 includes a variable delay circuit that can variably set a delay time, and a variable current driving circuit that can variably set a resonance frequency and amplitude, for example. Based on the delay amount information signal and the amplitude amount information supplied from the phase and amplitude adjustment circuit 14, the noise cancellation circuit 13 varies and sets the delay time from a switching point of the output signal 17 from the output circuit 12 to a starting time point of a power supply oscillation for noise-cancellation, the amplitude of the power supply oscillation, and the frequency of the power supply oscillation.

The resonance characteristic of the noise cancellation circuit 13 may be set by executing an SSN simulation in view of the impedance (inductance component in particular) of a power supply network of an LSI, a package, or a circuit board (PCB: Printed Circuit Board) and the chip capacitance (load capacitance of an output circuit or capacitance between the power supply and the GND, for example), so that the SSN oscillation noise will be canceled for the power supply network. The noise cancellation circuit 13 produces a power supply oscillation (an oscillation that damps exponentially, and an oscillation period is twice the delay time represented by the delay amount information), by delaying the signal 111 supplied from the preceding stage circuit 11 by a delay time represented by the delay amount information (½ of the oscillation period of the signal 111) and by adjusting an amplitude of the signal 111 based on the amplitude amount information. Bottoms of the power supply oscillation signal produced temporally match peaks of the power supply oscillation noise of the SSN generated when the output signal 17 from the output circuit 12 is switched and hence the peaks of the produced power supply oscillation temporally match bottoms of the power supply oscillation noise of the SSN. In this way, inclusive of the first peak (or bottom) of the oscillation noise of the SSN, the power supply oscillation and the power supply oscillation noise of the SSN counteract each other. As a result, the power supply oscillation noise of the SSN is cancelled. A capacitance C connected to the noise cancellation circuit 13 is implemented by a bypass capacitor connected to a power supply. Instead of such on-chip capacitance, the capacitance C may be connected to an external terminal.

In the present exemplary embodiment, the delay amount information and the amplitude amount information set in the noise cancellation circuit 13 may be supplied from the outside of the semiconductor LSI 1. In such case, for example, the delay amount information and the amplitude amount information is supplied from a Mode Resister Set (MRS) (not illustrated) provided in the semiconductor LSI 1. A DRAM includes a mode register for setting various modes and parameters. It is assumed that bit areas for holding the delay amount information and the amplitude amount information are allocated in advance in the mode register and the delay amount information and the amplitude amount information can be set by providing a mode register set command for setting parameters and the like in the mode register to the semiconductor LSI 1. The mode register is set, for example, during initialization when the power supply is turned on or during a reset operation. The mode register can be rewritten in an idle state. The phase and amplitude adjustment circuit 14 includes a storage unit (register) that holds the delay amount information and the amplitude amount information set in the mode registers (not illustrated) and supplies the delay amount information and amplitude amount information held in the storage unit to the noise cancellation circuit 13.

Alternatively, a measurement circuit (such as an on-chip sampling oscilloscope, not shown in the drawing) may be arranged in the semiconductor LSI to measure a power supply noise and to execute automatic adjustment (also termed as self-alignment) in the LSI. In case a measurement circuit (such as an on-chip sampling scope) for monitoring a power supply waveform is arranged in the semiconductor LSI, for example, a power supply noise waveform generated during switching of a DQ signal may be observed, and the period and the damped oscillation term of the waveform may be quantified by a CPU or the like provided in the semiconductor LSI. Alternatively, the semiconductor LSI may be operated by a tester or the like to monitor a power supply wave. In this way, the delay amount information and the amplitude amount information can be acquired based on a monitored SSN oscillation waveform, and the information can be set in the semiconductor LSI.

FIG. 2 illustrates operation principles of the noise cancellation circuit 13 in FIG. 1. In (i) of FIG. 2, there is illustrated a power supply voltage waveform (SSN waveform) generated when a plurality of output signals (DQ signals) 17 from output circuits (12 in FIG. 1) are simultaneously switched from a low level to a high level.

As illustrated in (i) of FIG. 2, the SSN waveform is represented by a combination of a spike-shaped noise (A) generated when the output signals 17 from the output circuits 12 are switched and an oscillation noise (power supply oscillation noise) (B) generated based on an impedance characteristic of a power supply network connected to the output circuits 12.

The waveform of the power supply oscillation noise (B) is determined by the anti-resonance characteristic of the power supply network impedance (mostly, the LC parallel resonance (the impedance viewed from the outside is theoretically infinite at a resonance frequency (=½π\sqrt{(LC)})). The power supply oscillation noise (B) oscillates with a certain period (=Td) and damps exponentially (exp (−αt): where α is a damping coefficient (α>0) and t is time). In (i) of FIG. 2, a line (envelope) connecting bottoms of the amplitude of the oscillation noise (B) is approximated by exponent function −k×exp (−αt) (where k is a positive constant). Similarly, a line (envelope) connecting peaks of the amplitude of the power supply oscillation noise (B) is approximated by exponent function k×exp (−αt).

The period Td and the damping coefficient α are dependent on the characteristic (inductance, capacitance, and the like) of the power supply network.

Thus, the period Td and the damping coefficient α each may be dealt as constant or unchanged unless at least one of the LSI (semiconductor), the package (QFP (Quad Flat Package), CSP (Chip Size Package), etc.), and the circuit board (PCB) is changed. Namely, if the LSI, the package, and the circuit board are unchanged, basically, the period Td and the damping coefficient α are identical.

In the present exemplary embodiment, the noise cancellation circuit 13 uses an oscillation noise generated in the power supply because of simultaneous switching of the output circuits 12, to cancel the oscillation noise. Namely, the noise cancellation circuit 13 produces an oscillation noise for cancelling out the power supply oscillation noise ascribable to the SSN, and makes the produced oscillation noise and the power supply oscillation noise ascribable to the SSN counteract each other.

More specifically, the noise cancellation circuit 13 includes a circuit (a circuit for manipulating a power) that produces a power waveform that corresponds to an oscillation noise generated in the power supply, as schematically illustrated in (ii) of FIG. 2. This circuit delays the power waveform corresponding to the oscillation noise by half the period Td/2, as illustrated in (iii) of FIG. 2. In addition, the circuit multiplies the amplitude of the power waveform corresponding to the oscillation noise by exp {α(Td/2)}, as illustrated in (C) in (iv) of FIG. 2 and a resulting power waveform is superimposed on or bumped against the power supply oscillation noise (B) originally generated.

Namely, after the original power supply oscillation noise (B) and the power supply oscillation (C) produced by the noise cancellation circuit 13 are combined together, the power supply voltage exhibits a waveform (power waveform) which is controlled to be kept constant after Td/2, as illustrated in (v) of FIG. 2.

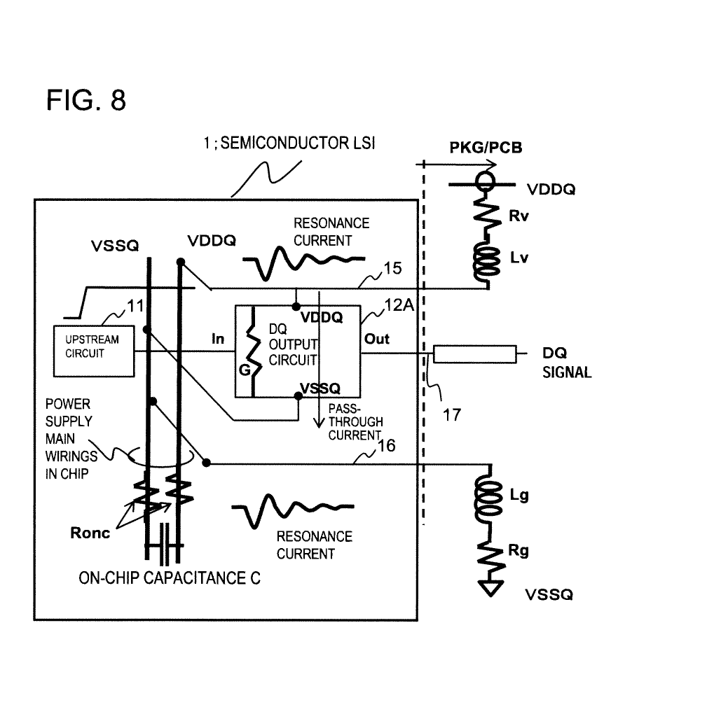

FIG. 8 illustrates a method of determining a resonance characteristic of the noise cancellation circuit 13 based on SSN simulation results in the present exemplary embodiment. In determining the resonance characteristic of the noise cancellation circuit 13, the noise characteristic of the output circuit 12 are important. In FIG. 8, for simplicity, the noise cancellation circuit 13 is not illustrated.

Following describes the noise characteristic of the output circuit 12. In the output circuit 12 (which is also referred to as “a DQ output circuit” or “a DQ output buffer”), when an input signal (an output from the preceding stage circuit 11) supplied to a node In is switched from a low level to a high level or from a high level to a low level, a pass-through current (a current flowing from the power supply VDDQ to VSSQ via NMOS and PMOS transistors, termed also as a short-circuit current) flows through NMOS and PMOS transistors forming a CMOS buffer (not illustrated) in the output circuit 12. Namely, a current flows between VDDQ and VSSQ. The waveform of this current is determined by the impedance between the VDDQ node and the VSSQ node of the output circuit 12. More specifically, the shape of the current waveform is mainly determined by the LC parallel resonance caused by parasitic inductances Lv and Lg in the power supply wirings 15 and 16 respectively connected to the power supplies VDDQ and VSSQ of a package (PKG) and a circuit board (PCB) and an on-chip capacitance C in the chip. In addition, the current waveform is a damped oscillatory waveform. This current flows through not only the VDDQ wiring 15 and the VSSQ wiring 16 but also the output circuit 12. Thus, the current results in a noise that disturbs the waveform of the output signal from the output circuit 12.

A resonance angular frequency ωd of the oscillation noise caused by this current is determined as follows:

ωd=1/\sqrt{{(Lv+Lg)×C}}

Based on this resonance angular frequency w d, the delay time by which the noise cancellation circuit 13 delays the signal 111 supplied from the preceding stage circuit 11, that is, the delay time specified by the delay amount information, can be determined as follows:

Td=2π/ωd

In addition, the damping coefficient α in FIG. 2 is determined by three parameters of R, L, and C forming the power supply network. More specifically, mainly based on parasitic resistances Rv and Rg in the power supply wirings 15 and 16 respectively connected to the power supplies VDDQ and VSSQ of the package (PKG) and the circuit board (PCB), the on-chip capacitance C in the chip, and a parasitic resistance Ronc of each of the power supply main wirings VDDQ and VSSQ in the chip, the damping coefficient α can be approximated as follows:

α≈1(2×C×Rp)

Rp=(Rv+Rg)×Ronc/{(Rv+Rg)+Ronc}

In the present exemplary embodiment, this approximation to hold accurately and hence by executing an SSN simulation and determining the parasitic resistances Rv and Rg parasitized in the power supply wirings 15 and 16 connected to the power supplies VDDQ and VSSQ of the package (PKG) and the circuit board (PCB), the on-chip capacitance C in the chip, and the parasitic resistance Ronc of each of the power supply main wirings VDDQ and VSSQ in the chip, the damping coefficient α can be determined. Quantitatively, if a resistance component is inserted in parallel to the LC parallel circuit, the smaller the value of the resistance component is, the smaller the damping coefficient α will be. On the other hand, if a resistance component is inserted in series with the LC parallel circuit, the larger the value of the resistance component, the smaller the damping coefficient α will be.

By executing a simulation to determine the amplitude of the pass-through current I1 generated between the power supply main wirings VDDQ and VSSQ when the output circuit 12 is operated, the amplitude of the pass-through current I2 generated between the power supply main wirings VDDQ and VSSQ when the noise cancellation circuit 13 is operated can be determined as follows:

I2=I1×exp(−α×(Td/2))

Thus, the resonance characteristic of the noise cancellation circuit 13 can be determined by executing an SSN simulation and determining: the inductances Lv and Lg being parasitic respectively in the power supply wirings 15 and 16 connected to the power supplies VDDQ and VSSQ, of the package (PKG) and the circuit board (PCB); the on-chip capacitance C in the chip, the resistances Rv and Rg being parasitic respectively in the power supply main wirings VDDQ and VSSQ of the package (PKG) and the circuit board (PCB), the parasitic resistance Ronc of each of the power supply main wirings VDDQ and VSSQ in the chip, and the pass-through current I1 generated between the power supply main wirings VDDQ and VSSQ when the output circuit 12 is operated. The determined resonance characteristics are supplied as the delay amount information and the amplitude amount information to the noise cancellation circuit 13.

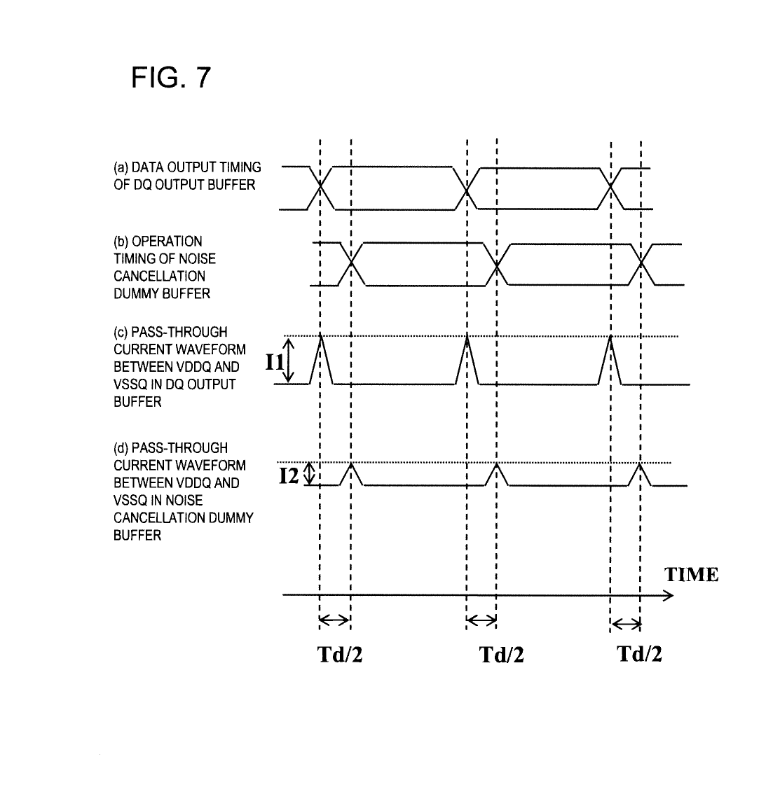

FIG. 7 illustrates a timing diagram of first exemplary embodiment. The noise cancellation circuit 13 (noise cancellation dummy buffer) is operated after elapse of a specific delay time, in view of an output timing of the output circuit 12 (DQ output buffer) in FIG. 1. The output timing of the noise cancellation circuit 13 (noise cancellation dummy buffer) is delayed from that of the output circuit 12 (DQ output buffer) by Td/2 in FIG. 2. As described above, when the noise cancellation circuit 13 (noise cancellation dummy buffer) is operated at a timing that is delayed from the output timing of the output circuit 12 (DQ output buffer) by Td/2, the amplitude 12 of the pass-through current that flows between the power supplies VDDQ and VSSQ, as illustrated in the waveform (c) in FIG. 7, is set as follows:

I2=I1×exp(−α×(Td/2))

where I1 is an amplitude of said pass-through current waveform flowing between said first and second power supply wirings at said output timing of said output circuit (the waveform (c) in FIG. 7), exp is an exponential function, α is a damping coefficient, and Td is an oscillation period of said power supply oscillation noise.

The pass-through current flows between the power supply main wirings VDDQ and VSSQ, when PMOS and NMOS transistors of a CMOS buffer connected between the power supplies VDDQ and VSSQ are simultaneously brought in an on-state.

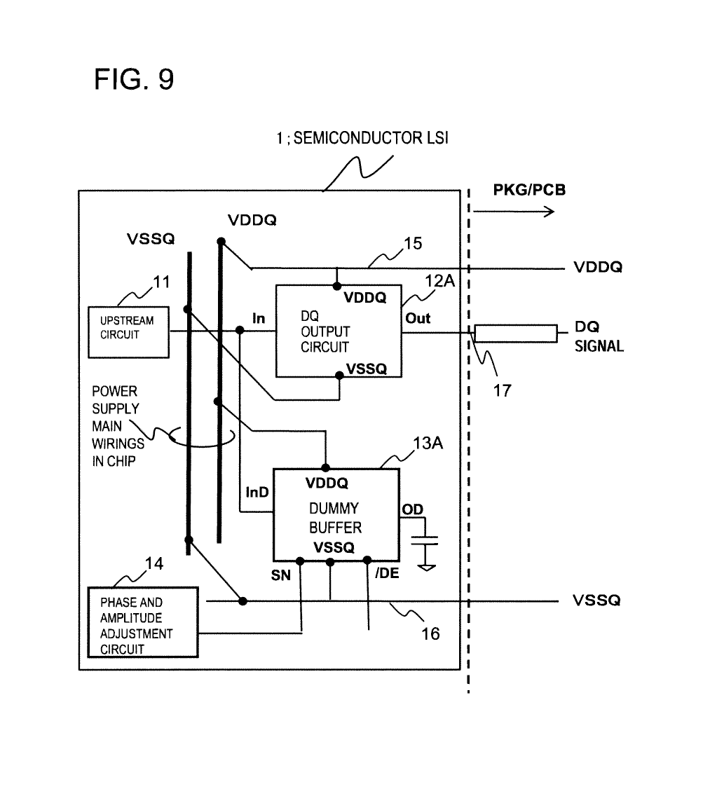

FIG. 9 illustrates a specific example of the first exemplary embodiment illustrated in FIG. 1. In the example in FIG. 9, the output circuit 12 and the noise cancellation circuit 13 in FIG. 1 are represented as a DQ output circuit 12A and a dummy buffer 13A, respectively. In addition, the data signal 111 supplied from the preceding stage circuit 11 to the DQ output circuit 12A is represented by In and the data signal 111 supplied from the preceding stage circuit 11 to the dummy buffer 13A is represented by InD. A dummy buffer enable signal /DE, which is active in a low level, is supplied to the dummy buffer 13A.

The dummy buffer 13A shares the power supplies VDDQ and VSSQ and the logic signal input InD outputted from the preceding stage circuit 11 with the DQ output circuit 12A. The dummy buffer 13A has a dummy output node OD, a node SN receiving a serial number signal for setting parameters, and a dummy buffer enable signal node /DE (active in a low level). The dummy output node OD is connected to a capacitance element having a capacitance value of several picofarads (pF). This capacitance value is approximately equal to a load capacitance (not illustrated) of a wiring connected to an output node of the DQ output circuit 12A and of a receiver that receives a DQ signal. To activate (operate) the dummy buffer 13A, a low level is supplied to the node /DE. To inactivate the dummy buffer 13A, a high level is supplied to the node /DE.

The phase and amplitude adjustment circuit 14 outputs information (SN) about phase and amplitude adjustment amounts to the dummy buffer 13A. For example, the phase and amplitude adjustment circuit 14 supplies the delay amount (Td/2) illustrated in FIG. 2 and FIG. 7 and information about the amplitude amount (for example, information about the amplitude of the pass-through current illustrated in FIG. 7) when the dummy buffer 13A is operated. The phase and amplitude adjustment circuit 14 may store phase and amplitude adjustment amounts, which are determined while the semiconductor LSI 1 is mounted on the circuit board, in registers (not illustrated) in the phase and amplitude adjustment circuit 14. In this case, the phase and amplitude adjustment amounts may be supplied externally, by using a mode register (not illustrated) or the like in the semiconductor LSI 1 (a command for setting information about the phase and amplitude adjustment amounts in the mode register is supplied to the semiconductor LSI mounted on the circuit board), and registers or the like arranged in the phase and amplitude adjustment circuit 14 may receive values from the mode resistors and hold the values.

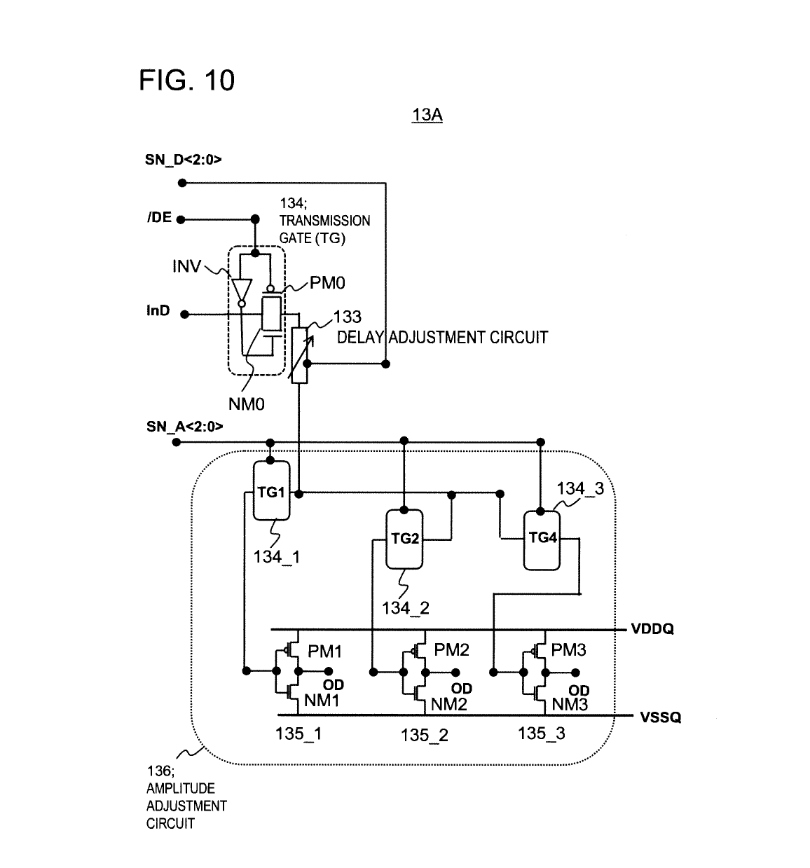

FIG. 10 illustrates a specific circuit configuration of the dummy buffer 13A in FIG. 9. As illustrated in FIG. 10, the dummy buffer 13A has input signal nodes, such as the dummy output node OD, the node SN for receiving a serial number signal for setting parameters, the dummy buffer enable signal node /DE, and the data input node InD. As in the case of the DQ output circuit 12A, CMOS buffers 135 are connected to the power supplies VDDQ and VS SQ.

The serial number signal SN in FIG. 9 is illustrated as two separate signals, which are an amplitude adjustment control signal SN_A<2:0> (3-bit signal) and a delay adjustment control signal SN_D<2:0> (3-bit signal).

The dummy buffer 13A includes a transmission gate (TG) 134 that controls a signal flow through the data input node InD, a delay adjustment circuit 133 that is connected to an output node of the transmission gate 134, and an amplitude adjustment circuit 136. The amplitude adjustment circuit 136 includes transmission gates (TG1 to TG3) 134_1 to 134_3 connected to an output node of the delay adjustment circuit 133, and CMOS buffers 135_1 to 135_3, each of which has an input connected to an output node of a corresponding one of the transmission gates (TG1 to TG3) 134_1 to 134_3, has an output connected to the dummy output node OD, and has a different gate width W.

The transmission gate (TG) 134 includes a PMOS transistor PM0 and an NMOS transistor NM0 connected in parallel. A control signal (dummy buffer enable signal /DE) is inverted by an inverter INV and the inverted signal is supplied to a gate of the NMOS transistor NM0. In addition, the control signal (dummy buffer enable signal /DE) is supplied to a gate of the PMOS transistor PM0. When the control signal (/DE) is at a low level, both the transistors PM0 and NM0 are turned on, and the terminal InD and an input node of the delay adjustment circuit 133 are electrically connected. When the control signal /DE is at a high level, both the transistors PM0 and NM0 are turned off, and the node InD is electrically disconnected from the delay adjustment circuit 133. As control signals, the transmission gates (TG1 to TG 3) 134_1 to 134_3 receive the respective bits of the control signal SN<2:0>. For example, when the LSB (Least Significant Bit) of the control signal SN 2:0> is ‘1’, the transmission gate (TG1) 134_1 is turned on. When the 1st bit of the control signal SN<2:0> is ‘1’, the transmission gate (TG2) 134_2 is turned on. When the 2nd bit of the control signal SN<2:0> the transmission gate (TG3) 134_3 is turned on.

The CMOS buffer 135_1 includes a PMOS transistor PM1 having a source connected to VDDQ, and an NMOS transistor NM1 having a source connected to VSSQ, a drain connected to a drain of the PMOS transistor PM1, and a gate connected to a gate of the PMOS transistor PM1. An input node of the CMOS buffer 135_1 is formed by the coupled gates of the PMOS transistor PM1 and the NMOS transistor NM1 and is connected to an output node of the transmission gate TG1. An output node of the CMOS buffer 135_1 is formed by the coupled drains of the PMOS transistor PM1 and the NMOS transistor NM1 and is connected to the node OD. In case the CMOS buffer 135_1 has a unit gate width W (×1), the CMOS buffer 135_2 and 135_3 have gate widths W twice (×2) and four times (×4) as large as the unit gate width W, respectively, though not limited thereto.

When the control signal /DE is at a low level, the transmission gate (TG) 134 is turned on to allow a signal to pass through the node InD and reach the delay adjustment circuit 133. The delay adjustment circuit 133 adds a delay based on a delay amount determined by the control signal SN_D<2:0> and transmits the signal to the next stage. In the example in FIG. 10, while the signal SN_D is illustrated as a 3-bit signal, the signal SN_D may have a greater or lower bit number. The delay adjustment circuit 133 supplies a delay time corresponding to the delay time Td/2 illustrated in FIG. 2 and FIG. 7.

Next, the signal delayed by the delay adjustment circuit 133 reaches the transmission gates (TG1 to TG3) 134_1 to 134_3 in the amplitude adjustment circuit 136. The transmission gates (TG1 to TG3) 134_1 to 134_3 control transfer of the signal to the CMOS buffers 135_1 to 135_3, each of which has a different gate width W.

Namely, if the signal SN_A<2:0> activates any one of the transmission gates (TG1 to TG3) 134_1 to 134_3, the activated transmission gate transfer the signal to a CMOS buffer connected thereto. A plurality of the transmission gates (TG1 to TG3) 134_1 to 134_3 may be turned on simultaneously. For example, if all the transmission gates (TG1 to TG3) 134_1 to 134_3 are turned on simultaneously, a total gate width of CMOS buffers is increased to be seven times as large as the unit gate width (CMOS buffer 134_1). Namely, the amplitude adjustment circuit 136 charges and discharges the capacitance element at the node OD, as a COMS buffer having a current driving capability seven times as large (in this case, the amplitude 12 of the pass-through current waveform flowing between the power supplies VDDQ and VSSQ of the dummy buffer in FIG. 7 exhibits a maximum value). Based on a 3-bit value of the signal SN<2:0>, the amplitude of the pass-through current in the dummy buffer is adjusted.

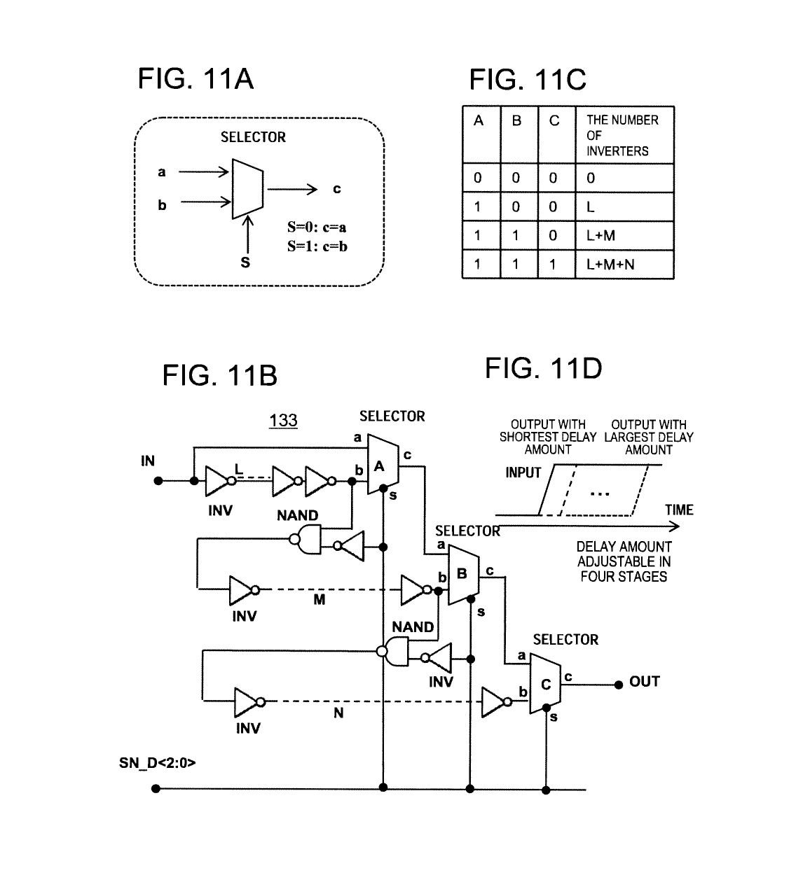

FIGS. 11A to 11D illustrate a specific circuit configuration of the delay adjustment circuit 133 of the dummy buffer 13A in FIG. 10.

As illustrated in FIG. 11B, the delay adjustment circuit 133 includes a signal input node IN, a signal output node OUT, and a control signal input node SN_D<2:0> for delay amount adjustment. Three selectors A to C control the number of inverter stages through which a signal is transferred. These selectors A to C have an identical configuration.

As illustrated in FIG. 11A, when a selection signal S is ‘0’, an output node c outputs a signal inputted to an input node a (when S=0, c=a). When the selection signal S is ‘1’, the output node c outputs a signal inputted to an input node b (when S=1, c=b).

Based on the circuit configuration illustrated in FIG. 11B, the delay amount can be controlled in four stages by the 3-bit control signal SN_D<2:0>. As illustrated in a truth table shown in FIG. 11C, in case all the 3 bits supplied to nodes S of the selectors A to C from the node SN_D<2:0> are ‘0’, all the selectors A to C select the respective input nodes a. As a result, a signal supplied through the node IN is outputted to the node OUT via the selectors A to C.

In case the signal supplied to the nodes S of the selectors A to C from the node SN_D<2:0> is ‘100’, the selector A selects the node b and the selectors B and C select the respective input nodes a. As a result, a signal supplied through the node IN is outputted to the node OUT via L stages of inverters INV and the selectors A to C. The delay time is set by the L stages of inverters.

In case the signal supplied to the nodes S of the selectors A to C from the node SN_D<2:0> is ‘110’, the selectors A and B select the respective nodes b, and the selector C selects the input node a. As a result, a signal supplied through the node IN is outputted to the node OUT via the L stages of inverters INV, a NAND gate (this NAND gate receives the selection signal S inputted to the selector A. Since the selection signal 5, which is supplied to one input of the NAND gate is, ‘1’, the NAND gate functions as an inverter), M stages of inverters, the node b of the selector B, and the node a of the selector C. The delay time is set by (L+M) stages of inverters. If a delay amount of the NAND gate and a delay amount α of the selector are considered, the delay time is set by (L+M+1) stages of inverters +α. Output signal from the selector A reaches the node a of the selector B, the selector B selects the node b and outputs an output signal therefrom.

In case the signal supplied to the nodes S of the selectors A to C from the node SN_D<2:0> is ‘111’, all the selectors A to C select the respective nodes b. As a result, a signal supplied through the node IN is outputted to the node OUT via the L stages of inverters INV, the NAND gate (this NAND gate receives the selection signal S inputted to the selector B. Since the selection signal S, which is supplied to one input of the NAND gate is, is ‘1’, the NAND gate functions as an inverter), the M stages of inverters, a NAND gate (this NAND gate receives the selection signal S inputted to the selector A. Since the selection signal S, which is supplied to one input of the NAND gate is, the NAND functions as an inverter), N stages of inverters, and the node b of the selector C. The delay time is set by (L+M+N) stages of inverters. If a delay amount of the NAND gate and a delay amount a of the selector are considered, the delay time is set by (L+M+2) stages of inverters +2α. Output signals from the selectors A and B reach the nodes a of the selectors B and C, respectively, the selectors B and C select the respective nodes b and output output signals therefrom.

The bit number of the control signal and the number of the selectors are not limited to 3. A greater number of bits and selectors may be used to realize more detailed delay adjustment. Alternatively, the delay adjustment circuit 133 may be configured by using a 2- or lower-bit control signal and two or less selectors.

FIG. 11D schematically illustrates an input waveform and output waveforms of the delay adjustment circuit 133. While the delay of the output waveform can be adjusted in four stages, FIG. 11D illustrates those output waveforms having the shortest and largest delay amounts with respect to the input waveform. FIG. 11D illustrates output signal delay waveforms that rise in phase with the input signal (falling of the output waveforms is in phase with falling of the input waveform). In this case, for example, each of the numbers L, M, and N of stages of inverters determining the delay time is an even number (M stages and N stages inclusive of the NAND gates are both even-numbers).

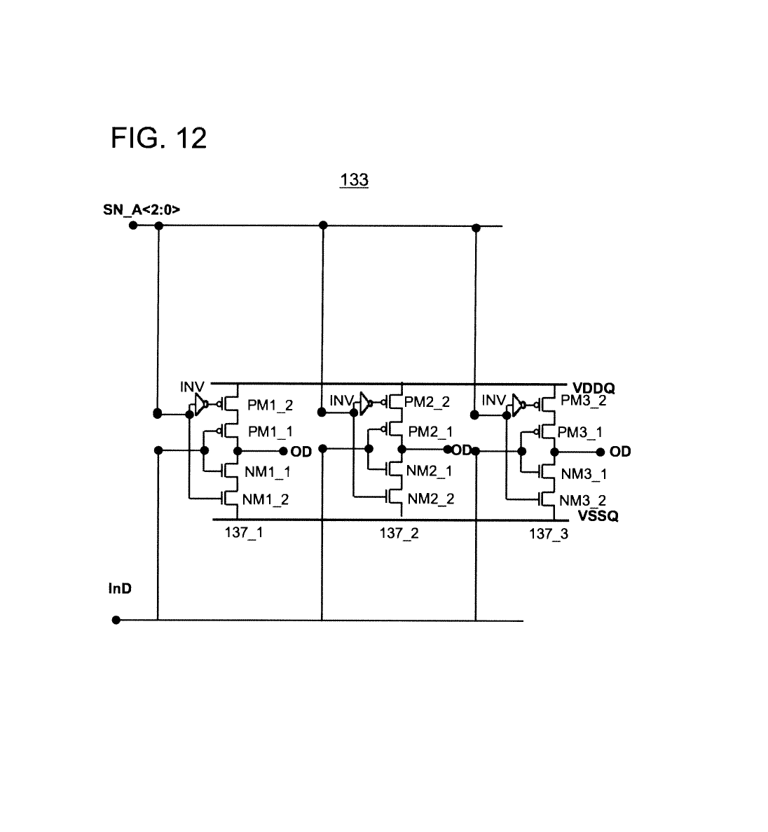

FIG. 12 illustrates another configuration example of the amplitude adjustment circuit 136 in the dummy buffer 13A. In FIG. 10, the amplitude adjustment circuit 136 includes a plurality of sets (three sets) of a transmission gate 134 and a CMOS buffer 135 for amplitude adjustment. In FIG. 12, a set of a transmission gate and a CMOS buffer is configured by a single clocked inverter. For example, a clocked inverter 137_1 includes a CMOS buffer, a PMOS transistor (PM1_2) inserted between a power supply node and a source node of a PMOS transistor (PM1_1) of the CMOS buffer, and an NMOS transistor (NM1_2) between a GND node and a source node of an NMOS transistor (NM1_1) of the CMOS buffer. The control signal SN_A<2:0> is inverted by an inverter INV, and the PMOS transistor (PM1_2) is turned on or off by the inverted signal of the corresponding bit of the control signal SN_A<2:0>. The NMOS transistor (NM1_2) is turned on or off by the corresponding bit of the control signal SN_A<2:0>.

The 0th bit (LSB) of the control signal SN<2:0> and a signal obtained by inverting the 0th bit by the inverter INV are supplied to a gate of the NMOS transistor NM1_2 and a gate of the PMOS transistor PM1_2 of the clocked inverter 137_1, respectively. If the value of the 0th bit is ‘1’, the clocked inverter 137_1 is activated to output an inverted signal of the input InD to the node OD. If the value of the 0th bit is ‘0’, the clocked inverter 137_1 is turned off.

The first bit of the control signal SN<2:0> and a signal obtained by inverting the 1st bit by an inverter INV are supplied to a gate of an NMOS transistor NM2_2 and a gate of a PMOS transistor PM2_2 of a clocked inverter 137_2, respectively. If the value of the 1st bit is ‘1’, the clocked inverter 137_2 is activated to output an inverted signal of the input InD to the node OD. In case the value of the 1st bit is ‘0’, the clocked inverter 137_2 is turned off.

The 2nd bit of the control signal SN<2:0> and a signal obtained by inverting the 2nd bit by an inverter INV are supplied to a gate of an NMOS transistor NM3_2 and a gate of a PMOS transistor PM3_2 of a clocked inverter 137_3, respectively. If the value of the 2nd bit is ‘1’, the clocked inverter 137_3 is activated to output an inverted signal of the input InD to the node OD. If the value of the 2nd bit is ‘0’, the clocked inverter 137_3 is turned off. If the clocked inverter 137_1 has a unit gate width (W) (×1), for example, the clocked inverters 137_2 and 137_3 are set to have gate widths (W) twice (×2) and four times (×4) as large as the unit gate width (W), respectively. The amplitude of the pass-through current of the dummy buffer is set by the 3-bit values of the control signal SN<2:0>.

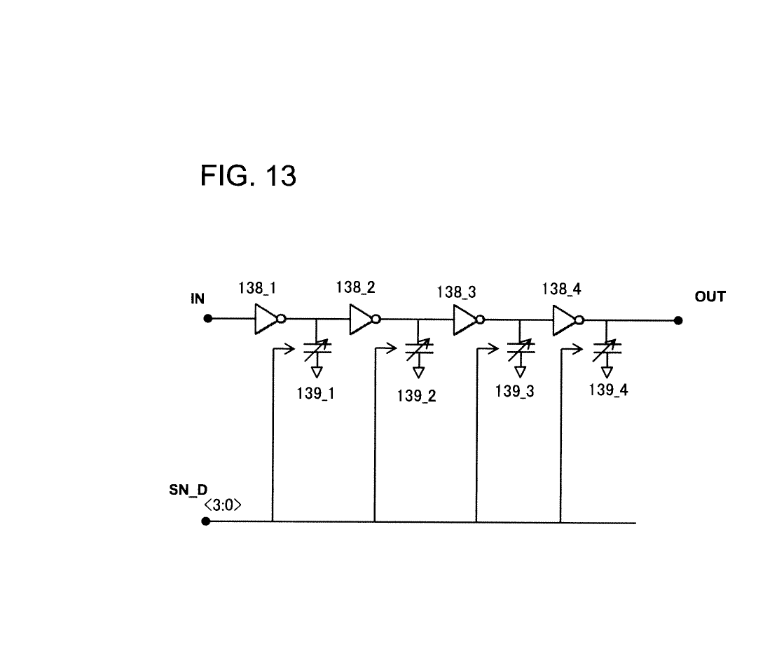

FIG. 13 illustrates another configuration example of the delay adjustment circuit 133 of the dummy buffer 13A in FIG. 10. As illustrated in FIG. 13, variable capacitance elements 139_1 to 139_4 are added to output signals from signal transmission inverters 138_1 to 138_4, respectively. In this case, the control signal SN_D is a 4-bit control signal SN<3:0>. The variable capacitance elements 139_1 to 139_4 change capacitance values, based on a voltage (a voltage representing binary values of high and low levels, for example) of the signal SN_D. In this way, the delay time transmitted from the node IN to the node OUT is changed in an analog manner. While not limited thereto, piezoelectric elements can be used as the variable capacitance elements 139_1 to 139_4. If the control signal SN_D is a 3-bit control signal SN<2:0>, for example, the variable capacitance element 139_4 connected to the output node of the inverter 138_4 is deleted.

### Exemplary Embodiment 2

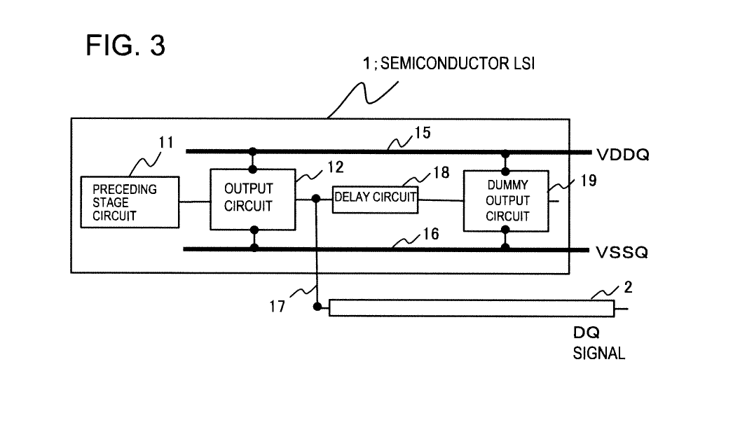

The following describes a second exemplary embodiment of the present invention. FIG. 3 illustrates a configuration of the second exemplary embodiment of the present invention. The noise cancellation circuit is not limited to the configuration of the above exemplary embodiment. In the present exemplary embodiment, the output signal 17 from the output circuit 12 is branched. Namely, the output signal 17 is connected to a signal wiring (DQ signal wiring) 2 of the circuit board and a delay circuit 18 in the semiconductor LSI 1.

In the present exemplary embodiment, the delay circuit 18 delays the output signal 17 from the output circuit 12 and supplies the delayed signal to a dummy output circuit 19. The dummy output circuit 19 is connected between the first power supply wiring 15 (VDDQ) and the second power supply wiring 16 (VSSQ) and includes an output buffer having a configuration identical to that of the output circuit 12. However, the output node of this output buffer is not extended to the outside of the LSI package. While no control nodes for the delay circuit 18 and the dummy output circuit 19 are illustrated in FIG. 3, the delay circuit 18 and the dummy output circuit 19 may have control nodes for adjusting a delay amount and a current amount during a circuit operation.

In case the configurations of the LSI, the package (QFP (Quad Flat Package), CSP (Chip Size Package), etc.), and the circuit board (PCB: Printed Circuit Board) have already been determined and a generated noise waveform can be evaluated in advance (or in case information about a noise waveform has already been obtained by a simulation or the like), a delay amount by the delay circuit 18 and a current amount by the dummy output circuit 19 are determined in advance. The delay circuit 18 can be configured by CMOS inverters cascade-connected in a plurality of stages (for example, an even number of stages). Each of the CMOS inverters is connected between the first power supply wiring 15 (VDDQ) and the second power supply wiring 16 (VSSQ). A variable delay circuit can be configured by changing the stage number of the CMOS inverters. Alternatively, a current source may be inserted in a power supply path of the CMOS inverter, and the bias voltage of the current source may be made variable. In this way, the unit delay time per CMOS inverter stage can be made variable.

The dummy output circuit 19 may be configured by CMOS buffer (CMOS inverter) circuits, as in the case of the output circuit 12. A current amount (power supply current) during an operation, in the dummy output circuit 19 may be adjusted as follows. A plurality (M) of CMOS inverters including transistors each having a smaller size (a smaller gate width W) than that of the CMOS buffer in the output circuit 12 are arranged in parallel, and the power supply current can be adjusted by connecting K-number (1≦K≦M) CMOS inverters out of the M-number of CMOS inverters to the feed system (that is by connecting K-number of CMOS inverters to the power supply path and operating the K-number of CMOS inverters). The gates of the K-number (1≦K≦M) of CMOS inverters in the dummy output circuit 19 may be configured to receive respective delay signals from the delay circuit 18, each having a different delay time.

In the present exemplary embodiment, the SSN oscillation noise is smoothed by causing the delay circuit 18 to delay a signal by (½) Td, where Td is a period of the SSN oscillation noise) and by causing the CMOS inverter of the dummy output circuit 19 that receives an output signal from the delay circuit 18 to make switching based on the delay time.

### Exemplary Embodiment 3

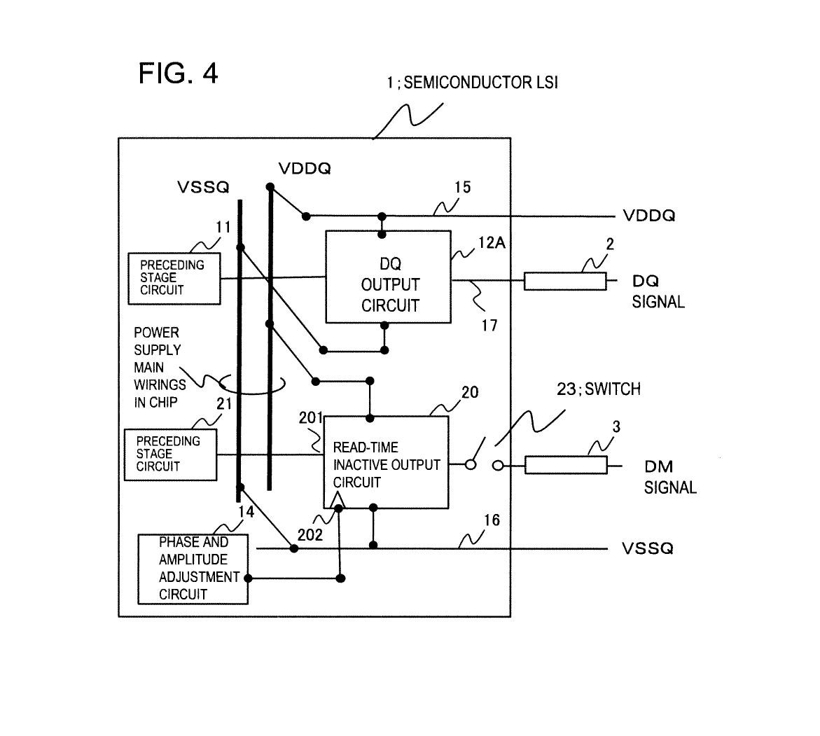

The following describes a third exemplary embodiment of the present invention. FIG. 4 illustrates the third exemplary embodiment of the present invention. In the present exemplary embodiment, a normally-used output buffer is used as a noise cancellation circuit. The SSN oscillation noise needs to be cancelled when a data signal is outputted from the semiconductor LSI 1. Namely, in the case of a DRAM or the like, the SSN oscillation noise needs to be cancelled only when a READ operation is executed. Thus, a READ-time inactive output circuit 20 can be used to cancel the SSN oscillation noise. The READ-time inactive output circuit 20 receives a signal requiring no logic conversion in a READ operation and shares the first power supply wiring 15 (VDDQ) and the second power supply wiring 16 (VSSQ) with a DQ output circuit 12A which outputs a data signal to a DQ node in a READ operation. Since a preceding stage circuit 11 and a DQ output circuit 12A in FIG. 4 are the same as the preceding stage circuit 11 and the output circuit 12 in FIG. 1, respectively, the description thereof will be omitted. A preceding stage circuit 21 connected to the READ-time inactive output circuit 20 supplies a switching signal to the READ-time inactive output circuit 20 simultaneously with the preceding stage circuit 11. There may be such a configuration wherein instead of the output signal from the preceding stage circuit 21, the READ-time inactive output circuit 20 receives an output signal from the preceding stage circuit 11 as a switching signal. The phase and amplitude adjustment circuit 14 is the same as the phase and amplitude adjustment circuit 14 in FIG. 1. The READ-time inactive output circuit 20 receives delay amount information and amplitude amount information from the phase and amplitude adjustment circuit 14 via input nodes 201 and 202. When a data signal is read, the READ-time inactive output circuit 20 operates in the same way as the noise cancellation circuit 13 described with reference to FIG. 1 and FIG. 2.

In the present exemplary embodiment, since the normally-used output circuit 20 (a READ-time inactive output circuit) is used, the increase in the circuit area is suppressed, as compared with the case in which the noise cancellation circuit 13 in FIG. 1 is additionally provided. In the present exemplary embodiment, in the case of a DRAM, a DM (data mask) signal, for example, corresponds to the signal requiring no logic conversion in a READ operation. During a WRITE operation, a switch 23 is turned on, and the READ-time inactive output circuit 20 receives the DM signal. As in the case with the DQ output circuit 12A, the READ-time inactive output circuit 20 is connected between the first power supply wiring 15 (VDDQ) and the second power supply wiring 16 (VSSQ). During a READ operation, the switch 23 arranged between a node connected to a signal wiring 3 transmitting the DM signal and the READ-time inactive output circuit 20 is turned off. Based on the delay amount information and the amplitude amount information from the phase and amplitude adjustment circuit 14, as illustrated in (iv) of FIG. 2, the READ-time inactive output circuit 20 cancels the oscillation noise (B) shown in (i) of FIG. 2.

During a READ operation, the switch 23 is turned off and the output is set in a High-Z state (high-impedance state). Alternatively, as the switch 23, a tri-state switch may be used to achieve a short circuit to the power supply of the output circuit 20 or to the ground.

### Exemplary Embodiment 4

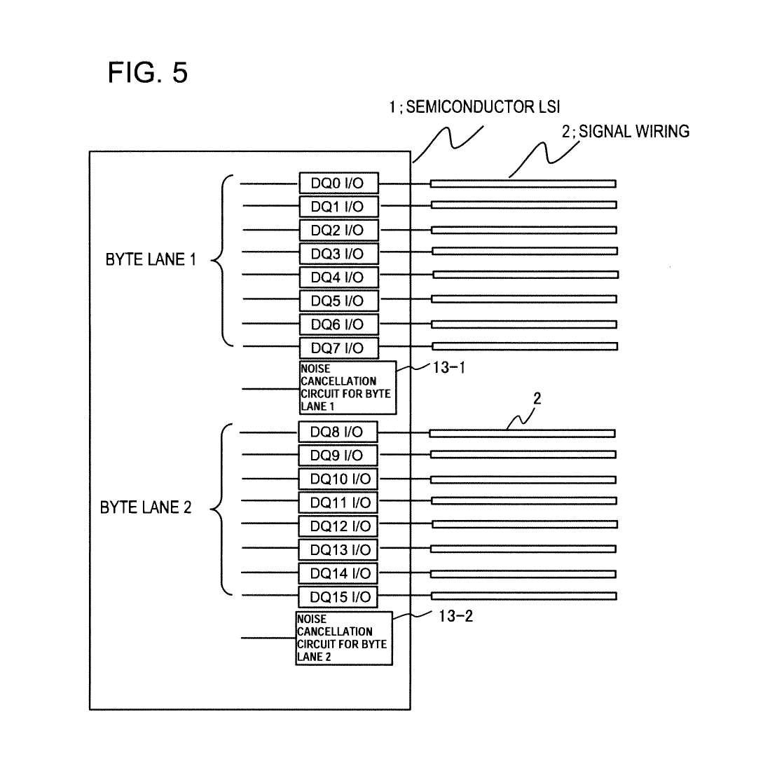

The following describes a fourth exemplary embodiment of the present invention. FIG. 5 illustrates a configuration of the fourth exemplary embodiment of the present invention. The SSN noise can be cancelled significantly if the noise cancellation circuit is arranged for each data signal (DQ) bit. However, in this case, the circuit area is increased. Thus, in the present exemplary embodiment, to cancel the SSN oscillation noise effectively, a noise cancellation circuit is arranged for output circuits of multiple bits. It is particularly effective if a noise cancellation circuit (13 in FIG. 1) is arranged for DQ I/O circuits (input/output circuits) of a byte lane (8 bits), which forms an 8-bit parallel output unit. Each of the DQ I/O circuits (input/output circuits) includes an output circuit (the output circuit 12 in FIG. 1 connected between the first power supply wiring VDDQ and the second power supply wiring VSSQ). When a data signal (DQ signal) is inputted in a WRITE operation, the output node of the output circuit is brought in a High-Z state (high-impedance state) and is electrically disconnected from the input/output node. Noise cancellation circuits 13-1 and 13-2 for byte lanes 1 and 2, respectively, are also connected between the first power supply wiring VDDQ and the second power supply wiring VSSQ.

While depending on the layout of the package and the layout in the chip, the present exemplary embodiment is effective, for example, when circuits are connected and wirings are installed in the chip and signal wirings are arranged outside the chip, separately on per a byte lane. This is because the noise is saturated per byte lane. That is, since the SSN noise generated in a byte lane is basically independent of (uncorrelated to) other byte lanes, it is only sufficient to cancel the SSN noise per byte lane. In FIG. 5, as in the case of the noise cancellation circuit 13 in FIG. 1, the noise cancellation circuits 13-1 and 13-2 for DQO I/O to DQ7 I/O and DQ8 I/O to DQ15 I/O in byte lanes 1 and 2, respectively, cancel the SSN oscillation noise, based on the delay and amplitude amount information supplied from the phase and amplitude adjustment circuit not illustrated (14 in FIG. 1), as illustrated in (iv) of FIG. 2.

### Exemplary Embodiment 5

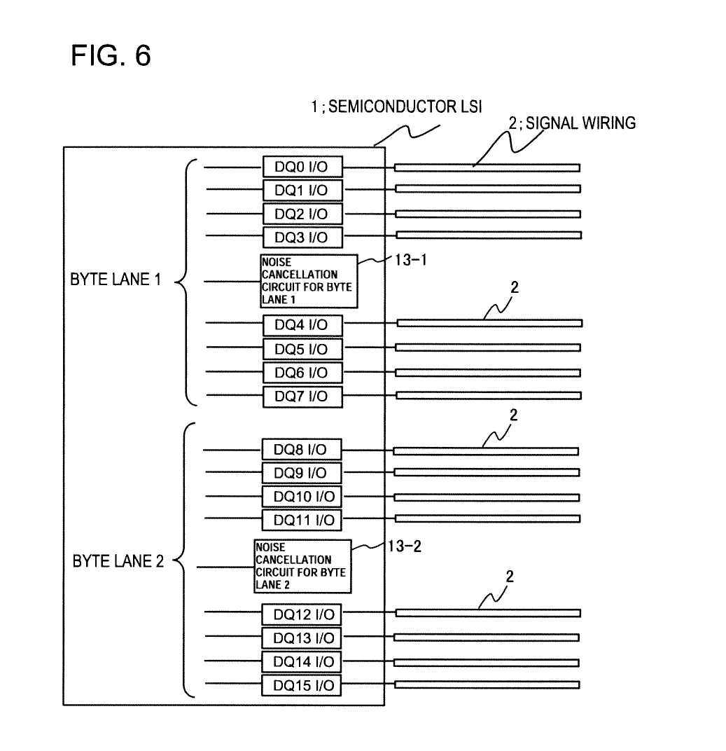

The following describes a fifth exemplary embodiment of the present invention. FIG. 6 illustrates a configuration of the fifth exemplary embodiment of the present invention. In the above described fourth exemplary embodiment, the noise cancellation circuits 13-1 and 13-2 are arranged for the respective byte lanes. However, in the fifth exemplary embodiment, the noise cancellation circuits 13-1 and 13-2 are arranged in the middle of the respective byte lanes. More specifically, the noise cancellation circuit 13-1 is arranged between a 4-bit group of DQO I/O to DQ3 I/O and a 4-bit group of DQ4 I/O to

DQ7 I/O, and the noise cancellation circuit 13-2 is arranged between a 4-bit group of DQ8 I/O to DQ11 I/O and a 4-bit group of DQ12 I/O to DQ15 I/O. In FIG. 6, as in the case of the noise cancellation circuit 13 in FIG. 1, the noise cancellation circuits 13-1 and 13-2 in byte lanes 1 and 2 cancel the SSN oscillation noise, based on the delay and amplitude amount information supplied from the phase and amplitude adjustment circuit not illustrated (14 in FIG. 1), as illustrated in (iv) of FIG. 2. In the present exemplary embodiment, four DQ I/Os are symmetrically arranged on either side of each of the noise cancellation circuits 13-1 and 13-2 for byte lanes 1 and 2. Thus, improvement in noise cancellation efficiency is expected.

According to the above exemplary embodiments, since the SSN oscillation noise can be reduced, the signal deterioration such as distortion of a signal waveform can be prevented. As a result, high-speed single-ended signal transmission can be realized. The above exemplary embodiments are not limited to high-speed transmission systems and are as a matter of course applicable to relatively low speed operation systems and products. For example, the above exemplary embodiments are also applicable to consumer appliances such as digital consumer products requiring a low jitter.

The disclosures of the above Patent Documents 1 and 2 are incorporated herein by reference thereto. Modifications and adjustments of the exemplary embodiments and examples are possible within the scope of the overall disclosure (including the claims) of the present invention and based on the basic technical concept of the present invention. Various combinations and selections of various disclosed elements (including the elements in each of the claims, examples, drawings, etc.) are possible within the scope of the claims of the present invention. That is, the present invention of course includes various variations and modifications that could be made by those skilled in the art according to the overall disclosure including the claims and the technical concept.

What is claimed is:

1. A device comprising:
first and second power supply lines supplied respectively with first and second power supply voltages;
a first output circuit coupled between the first and second power supply lines and responding to a first input signal to operate on the first and second power supply voltages;
an oscillation adjustment circuit storing adjustment information, generating adjustment signals in response to the adjustment information; and
a noise cancellation circuit coupled between the first and second power supply lines and producing, in response to the adjustment signals, a power supply oscillation that is generated at an adjustable generation timing and has an adjustable amplitude, the noise cancellation circuit responding to the first input signal to supply at least one of the first and second power supply lines with an adjusted power supply oscillation that is generated at an adjusted generation timing and has an adjusted amplitude.

2. The device as claimed in claim 1, wherein the adjustment information includes first information indicative of the adjusted generation timing of the adjusted power supply oscillation and second information indicative of the adjusted amplitude of the adjusted power supply oscillation.

3. The device as claimed in claim 2, wherein each of the first and the second information of the adjustment information is related to a configuration of the device, a package housing the device, or a power supply network connected to a board on which the package is mounted.

4. The device as claimed in claim 1, wherein the adjusted generation timing is after the first output circuit starts an operation in response to the first input signal.

5. The device as claimed in claim 1, wherein the adjusted amplitude is an attenuation amplitude.

6. The device as claimed in claim 1, wherein the at least one of the first and second power supply lines is caused a power supply noise when the first output circuit operates in response to the first input signal, the power supply noise includes a spike-shaped noise and an oscillation noise, and the adjusted power supply oscillation is relative to the oscillation noise.

7. The device as claimed in claim 6, wherein the adjusted power supply oscillation is substantially complementary in phase to the oscillation noise of the power supply noise.

8. The device as claimed in claim 6, wherein a period from a start of an operation of the first output circuit in response to the first input signal to the adjusted generation timing is substantially equal in length to a half of a cycle of oscillation of the adjusted power supply oscillation.

9. The device as claimed in claim 1, wherein the adjustment signal includes a delay adjustment signal, the noise cancellation circuit includes a delay circuit receiving the first input signal and delaying the first input signal for a delay time, that is adjustable, in response to the delay adjustment signal to produce a delayed signal.

10. The device as claimed in claim 1, wherein the noise cancellation circuit includes a plurality of buffers each coupled between the first and second power supply lines and operating, when activated, on the first and second power supply voltages, the adjustment signals includes an amplitude adjustment signal, and one or ones of the buffers designated by the amplitude adjustment signal is activated to generate the adjusted power supply oscillation.

11. The device as claimed in claim 10, wherein the adjustment signal further includes a delay adjustment signal, the noise cancellation circuit further includes a delay circuit receiving the first input signal and delaying the first input signal for a delay time, that is adjustable, in response to the delay adjustment signal to produce a delayed signal, and the one or ones of the buffers operates on the first and second power supply voltage in response to the delayed signal to generate the adjusted power supply oscillation.

12. The device as claimed in claim 1, further comprising an output terminal coupled to the first output circuit, and wherein the first output circuit driving the output terminal to one of first and second logic levels in response to the first input signal.

13. The device as claimed in claim 1, further comprising a plurality of second output circuits each coupled between the first and second power supply lines and responding to a corresponding one of a plurality of second input signals to operate on the first and second power supply voltages.

14. A semiconductor device, comprising:
first and second power supply wirings that are connected to first and second power supplies, respectively;
an output circuit that is connected between said first and second power supply wirings and includes an output node to output an output signal;
a delay circuit that includes an input node connected to said output node of said output circuit and delays said output signal of said output circuit received at said input node with a delay time variably set and outputs a resulting delayed signal; and
a dummy output circuit that is connected between said first and second power supply wirings and receives said delayed signal from said delay circuit, said dummy output circuit comprising a plurality of output buffers connected in parallel between said first and second power supply wirings, wherein among said plurality of output buffers, a predetermined certain number of output buffers are activated.

15. The semiconductor device as claimed in claim 1, comprising:
a second output circuit that is arranged in said semiconductor device and is connected between said first and second power supply wirings, wherein said second output circuit receives a signal supplied to a predetermined input terminal, and remains inactive when an output signal is outputted from said output circuit, said second output circuit serving as said noise cancellation circuit; and
a switch that electrically disconnects said input terminal from said second output circuit when said output signal is outputted from said output circuit.

16. The semiconductor device as claimed in claim 1, wherein said noise cancellation circuit is provided for a predetermined number of said output circuits arranged in parallel and respectively outputting output signals, said predetermined number of said output signals corresponding to a unit.

17. The semiconductor device as claimed in claim 16, wherein said noise cancellation circuit is disposed at one end of an array of said predetermined number of said output circuits arranged in parallel, said number of said output circuits corresponding to said unit.

18. The semiconductor device as claimed in claim 16, wherein said noise cancellation circuit is disposed in a middle of an array of said predetermined number of said output circuits arranged in parallel, said number of said output circuits corresponding to said unit.

19. A device comprising:
first and second power supply lines supplied respectively with first and second power supply voltages;
an output terminal;
a first circuit generating a first signal;
a first buffer coupled between the first and second power supply lines respectively at power nodes thereof and coupled to the output terminal at an output node thereof, the first buffer receiving the first signal at an input node thereof and driving the output terminal to one of first and second logic levels in response to the first signal;
a delay circuit receiving the first signal, delaying the first signal for a delay time, that is adjustable, to produce a second signal; and
a second buffer coupled between the first and second power supply lines respectively at power supply nodes thereof, the second buffer being indicative of an adjustable driving ability, receiving the second signal at an input node and driving an output node thereof at an adjusted driving ability to one of the first and the second logic levels in response to the second signal.

20. The device as claimed in claim 19, further comprising an adjustment circuit storing first and second adjustment information, generating, in response to the first adjustment information, a first adjustment signal that is indicative of the delay time and generating, in response to the second adjustment information, second adjustment signal that is indicative of the adjusted driving ability.
